(19) United States
(12) Patent Application Publication
(10) Pub. No.: US 2020/0376555 A1
(43) Pub. Date: Dec. 3, 2020

(54) METHOD AND DEVICE FOR THE ADDITIVE PRODUCTION OF A COMPONENT AND COMPONENT

(71) Applicant: Siemens Aktiengesellschaft, Munich (DE)

(72) Inventors: Johannes Casper, Munchen (DE); Henning Hanebuth, Pliening OT Gelting (DE); Matthias Goldammer, München (DE); Herbert Hanrieder, Hohenkammer (DE)

(73) Assignee: Siemens Aktiengesellschaft, Munich (DE)

(21) Appl. No.: 16/770,325

(22) PCT Filed: Nov. 21, 2018
(86) PCT No.: PCT/EP2018/082124

§ 371 Date: Jun. 5, 2020

(30) Foreign Application Priority Data
Dec. 18, 2017 (DE) 10 2017 130 282.4

(51) Int. Cl. B22F 3/105; B33Y 10/00; B33Y 30/00; B33Y 50/02

(52) U.S. Cl. CPC B22F 3/1055; B33Y 10/00; B22F 2003/1057; B33Y 50/02; B33Y 30/00

(57) ABSTRACT

A method for the additive production of a component, wherein a plurality of layers made in particular of a powder-like material is provided in succession and each material layer is scanned by an energy beam according to a specified component geometry. A component section already produced and/or the respective material layer provided and/or of a work platform on which the component is constructed is additionally heated. For at least one material layer, the temperature distribution on the surface on which the material layer is provided and/or the temperature distribution on the surface of the layer provided is measured. During the scanning process of the material layer, the energy quantity introduced by the energy beam is varied as a function of the temperature distribution detected on the surface on which the layer is provided, and/or as a function of the temperature distribution detected on the surface of the layer.

### CROSS REFERENCE TO RELATED APPLICATIONS

This application is the US National Stage of International Application No. PCT/EP2018/082124 filed 21 Nov. 2018, and claims the benefit thereof. The International Application claims the benefit of German Application No. DE 10 2017 130 282.4 filed 18 Dec. 2017. All of the applications are incorporated by reference herein in their entirety.

### FIELD OF INVENTION

The invention relates to a method for the additive production of a component, in particular for a turbomachine, in which a plurality of layers, more particularly a plurality of layers of a powdery material, are successively provided and each material layer is scanned by means of at least one energy beam, more particularly at least one laser beam, according to a specified component geometry, with there being additional heating of an already produced component section and/or of the respectively provided material layer and/or of a work platform on which the component is constructed.

Moreover, the invention relates to an apparatus for the additive production of a component, in particular for a turbomachine, comprising—a work region, defined above a work platform in particular, —means for providing material layers, in particular powdery material layers, above one another in the work region, —an energy beam device, more particularly a laser beam device, which is embodied and configured to emit at least one energy beam, more particularly at least one laser beam, and scan over material layers provided in the work region with the at least one energy beam, more particularly the at least one laser beam, according to a specified component geometry, —means for heating, more particularly inductively heating, a material layer provided in the work region and/or an already produced component section and/or the work platform.

Finally, the invention relates to a component, in particular for a turbomachine.

### BACKGROUND OF INVENTION

Components, in particular components with complex geometric shapes, may not be realized, or may only be realized with comparatively large effort, by subtractive manufacturing methods in certain circumstances. In this context, additive manufacturing methods (AM) come to the fore in recent years as alternatives.

Methods and apparatuses for the additive production of components are sufficiently well known from the prior art. In these construction methods, a multiplicity of material layers, more particularly powdery material layers, are successively provided on one another and each layer is scanned by means of one or more energy beams, more particularly laser or electron beams, according to a specified component geometry and locally fused or sintered as a result thereof. In the process, as many layers as necessary are provided, and are each scanned by the at least one energy beam, until the component to be produced has been completed.

Examples of additive production methods include selective laser melting (SLM) or selective electron beam melting (SEBM) and examples of selective laser sintering (SLS) or selective electron beam sintering (SEBS) from the powder bed include laser powder build-up welding (LPA).

By way of example, DE 10 2014 222 302 A1 has disclosed a method and an apparatus for additive production of components by SLM from the powder bed. Here, the layer-by-layer construction of a component is implemented on a height-adjustable work platform, which forms the base of a manufacturing cylinder, and means are provided for the provision of powder layers, said means comprising a storage cylinder, disposed next to the work platform, with a base that is able to be raised and a distributing device embodied as a doctor blade, by means of which powder can be conveyed from the storage cylinder to the manufacturing cylinder and can be smoothed. Powder provided in the storage cylinder is gradually pressed upward by the latter by lifting said storage cylinder's base and is transferred layer-by-layer to the adjacently situated build platform and distributed there by means of the doctor blade.

In principle, the known apparatuses and methods for additive manufacturing have proven their worth. They offer, inter alia, the great advantage of a great degree of flexibility in respect of the obtainable component geometries.

However, within the scope of additive methods, the energy influx from the one or more scanning beams, for instance laser beams or electron beams, is very local and the option for dissipating heat is comparatively poor, particularly in the powder bed. Therefore, pronounced thermal gradients may occur and this may lead to the formation of heat cracks. This problem is particularly pronounced in cases where components should be produced from materials that are difficult to weld. Purely by way of example, reference is made here to high temperature alloys and Ni, Co and Fe elements, as are used, inter alia, for rotor blades and guide vanes and also burner components of turbines.

In light of this problem, materials that are difficult to weld cannot, as a rule, be processed with high quality within the scope of additive manufacturing, and so the advantages linked to this manufacturing process tend to be restricted to materials that can be welded comparatively well.

Additional heating, in particular preheating to temperatures above 1000° C., for example, offers a promising option for also being able to make use of materials that are difficult to weld within the scope of additive manufacturing. Should the material layer to be scanned and/or a component section possibly already situated therebelow be heated prior to and/or during the scanning procedure, it is possible to avoid or at least reduce fast cooling and the risk of the formation of heat cracks connected therewith. Various options are available for heating the material layer and/or component, or else an entire process chamber in which additive manufacturing occurs, including ohmic heating, inductive heating, heating by means of IR beams or else heating by means of electron beams.

By way of example, the type of heating specified last is provided as per DE 10 2015 201 637 A1 within the scope of SLM from the powder bed. There, means for additional heating are present, which comprise an electron beam source disposed above the powder bed, by means of which an electron beam can be directed on the powder bed from above in perpendicular fashion. The electron beam is directed on the material layer prior to, during and/or after laser melting of same. The laser source is located to the side of the powder bed and the scanning beam is directed to the powder bed obliquely from the side so that the electron beam is not blocked.

Additional heating by inductive heating by means of at least one coil, disposed above and/or around the powder bed, within the scope of SLM or SLS is described in EP 2 572 815 A1.

DE 10 212 206 122 A1 discloses the performance of additional heating, specifically inductive heating, of the component to be produced within the scope of an additive manufacturing method, for example laser powder build-up welding or selective irradiation of a powder bed. To this end, the means for additional inductive heating likewise comprise at least one coil, with DE 10 212 206 122 A1 providing for the at least one coil to be movable and for its position to be changed during the additive manufacturing process.

Additional heating allows better results to be obtained, in particular to obtain components with improved properties, since the formation of cracks is avoided or at least reduced—even if materials that are difficult to weld are used.

However, there still is the need to further optimize the manufacturing process and, in particular, to obtain components with excellent quality, even in the case of components made of materials that are difficult to weld.

### SUMMARY OF INVENTION

It is therefore an object of the present invention to specify a method and an apparatus of the type set forth at the outset, which facilitate this.

In the case of a method of the type set forth at the outset, this object is achieved by virtue of the fact that, for at least one material layer, in particular for each material layer, the temperature distribution on the surface on which the material layer is provided is captured using measurement technology, in particular prior to the provision of the layer, and/or the temperature distribution on the surface of the provided layer is captured using measurement technology, and by virtue of the fact that, within the scope of the procedure of scanning over the material layer, the amount of energy introduced by the at least one energy beam is varied depending on the captured temperature distribution on the surface on which the layer is provided and/or depending on the captured temperature distribution on the surface of the layer, in particular varied in such a way that an inhomogeneity of the temperature distribution is reduced or compensated.

The present invention is based on the discovery that, as a rule, a homogeneous temperature distribution is not obtained within the scope of additional warming or heating in the case of additive production methods which, in particular, also facilitates processing of materials that are difficult to weld. Rather, a temperature profile with at least a certain degree of inhomogeneity arises in the respectively provided material layer or in an already produced component section situated therebelow, which are linked to various disadvantages. Substantial disadvantages of an inhomogeneous temperature distribution include, for example, a non-uniform temperature extent in the material and inaccuracies in the material application connected therewith, an uncontrollable lateral heat flux in the component under construction and the risk of cracks as a result of tension in distant component regions. The component quality can be impaired, process-related defects cannot be reliably avoided, it may be necessary to slow down the build process and restrictive boundary conditions in respect of the design freedom may arise.

According to the invention, this problem is countered by virtue of the additional heating and the scanning process, more particularly the fusing or sintering process, with the at least one energy beam being optimally matched to one another, specifically by virtue of controlling the at least one energy beam in targeted fashion in order to compensate inhomogeneities which set in as a consequence of the additional heating, for example as a consequence of inductive heating. According to the invention, the flexibility of the at least one energy beam is used to compensate for a non-uniform temperature distribution.

To this end, according to the invention, the heat distribution that has arisen and/or is arising as a consequence of the additional heating, in particular, is captured using measurement technology—at least over a region of a provided material layer, for instance the region to be scanned—and the at least one energy beam used to scan the material layer is then controlled in compensating fashion depending on the measurement. To this end, the energy influx introduced by way of the at least one energy beam, more particularly the at least one laser beam, is adapted during the scanning procedure by the variation of suitable parameters. In particular, the amount of energy introduced per unit volume and/or per unit time is varied in the process.

A particularly homogeneous introduction of energy and hence a significant improvement in the quality are obtained by the procedure according to the invention. The process stability is increased and the demands on the concept for the additional heating can be reduced. For instance, if an existing heating concept only supplies a comparatively inhomogeneous temperature distribution, this can be accepted and can be compensated for in comparatively simple fashion purely by way of an adapted energy beam control. A further significant advantage of the procedure according to the invention consists of faster heating times being able to be obtained, and consequently a reduction in the build time and in costs.

The materials from which components are manufacturable in additive fashion when carrying out the method according to the invention can include, in particular, all metals that are heatable by induction, advantageously nickel, iron or cobalt base materials.

By way of example, the capture of the temperature distribution on the surface of a material layer, or on the surface on which the latter is provided, by measurement technology can be implemented at specified, suitable times, for instance before or after the provision of a layer. Particularly advantageously, the capture by measurement technology and/or the evaluation of the captured temperature distribution, for instance a captured thermal image, is implemented in temporal proximity to the subsequent scanning procedure with at least one energy beam.

Additionally, the temperature distribution can be recorded continuously or quasi-continuously in the style of a conventional video, for example using a suitable camera, and then it is possible, in particular, to resort to individual frames. It should be noted that continuous or quasi-continuous, as is conventional, should also be understood to mean a plurality of recordings implemented in succession, albeit with a high time resolution, e.g., several or several ten frames per second.

Further, both a block-type procedure, in which a temperature distribution is captured per section, or else completely continuous recording are possible, an adaptation being undertaken in the latter for each recorded thermal image of the camera for the purposes of regulating the energy influx, e.g., regulating the power.

According to a further embodiment, the temperature distribution is captured at least over that region of the surface over which the region of the respective material layer to be scanned extends. Additionally, provision can be made for the measured region to “migrate along”, for instance for the temperature always to be captured over a region with a specified extent, which always includes, or is always defined relative to, the current point of incidence of at least one energy beam and/or the region which is additionally heated, more particularly in inductive fashion. In order to avoid oversaturation, which may lead to unrepresentative results, provision is made in a particularly advantageous embodiment for the melt pool present in the region of incidence of the at least one energy beam, more particularly the at least one laser beam, to be masked and/or left unaccounted for when capturing the temperature distribution using measurement technology.

Since, as a rule, a component to be produced is constructed on a work platform, provision according to one embodiment can be made, for the first and lowermost material layer, for the temperature distribution on the surface of a work platform on which the first layer is provided to be captured using measurement technology, in particular prior to the provision of the first layer, and for, within the scope of the procedure of scanning over the first layer, the amount of energy introduced by the at least one energy beam to be varied depending on the captured temperature distribution on the surface of the work platform.

A further embodiment of the method according to the invention is distinguished by virtue of the fact that the amount of energy introduced by the at least one energy beam during the scanning procedure is varied by virtue of the intensity and/or the power and/or the pulse duration and/or the beam or focal diameter and/or the displacement speed of the at least one energy beam and/or the intensity of scanning vectors, more particularly scanning lines, along which the at least one energy beam is moved over the material layer, being varied during the scanning procedure. These parameters were found to be particularly suitable for adapting the energy yield during the scanning procedure on the basis of a captured temperature distribution for the purposes of compensating inhomogeneities in the latter. For instance, if the energy beam guidance, more particularly the laser guidance, is increased while the energy beam is moved along a scanning line over a provided material layer, a temperature gradient which emerges from the preheating and which drops in the direction of this scanning line can be compensated for and vice versa.

In a further advantageous configuration, the temperature distribution on the surface on which the material layer is provided is captured using measurement technology by virtue of a thermal image of this surface being recorded by means of a thermographic camera. As an alternative or in addition thereto, the temperature distribution on the surface of the material layer can be captured in analogous fashion using measurement technology by virtue of a thermal image of the surface of the material layer being recorded by means of a thermographic camera. In particular, a thermographic camera should be understood to mean any type of camera that facilitates contactless and extensive determination of temperatures of object surfaces, such as thermal imaging cameras, for example. In particular, a thermographic camera operates analogously to a camera for the visual wavelength range with, however, recordings being created, as a rule, in the infrared wavelength range. Accordingly, a thermographic camera usually has a detector that is predominantly sensitive in the infrared wavelength range. The wavelength of a camera used, in particular the wavelength of the detector of same, expediently corresponds to the target temperature of the heating to the extent that sufficient thermal radiation is output in the wavelength range of the camera in order to be able to be detected by the camera. Here, the intensity of the emitted radiation correlates with the temperature, and so there can be a conversion to the temperature by way of a calibration of the received radiation intensity.

Should a thermal image be recorded, the latter can be evaluated, the energy introduced by the at least one energy beam then advantageously being varied depending on the result of the evaluation.

Obtained surface thermal images are available, in particular, in the form of temperature values for each camera pixel and can be used for further processing. By way of example, the temperatures can be presented in the form of false color or grayscale images for the purposes of presenting these to the user. Then, an associated scale can assign temperatures to grayscale or color values.

By way of example, at least one temperature gradient could be ascertained or calculated on the basis of a thermal image. The energy introduced by the at least one energy beam can then be varied during the scanning procedure depending on the calculated temperature gradient. By way of example, it is possible for the energy beam guidance, more particularly the laser guidance, to be modulated along a scanning vector, more particularly along a scanning line, in such a way that an inhomogeneity of a captured temperature distribution is counteracted.

In particular, the variation during a scanning procedure can be such that the amount of energy introduced by the at least one energy beam is increased where there is a comparatively lower temperature according to the captured temperature distribution and/or the amount of energy introduced by the at least one energy beam is reduced where there is a comparatively higher temperature according to the captured temperature distribution. Then, comparatively means, in particular, in comparison with another point of a material layer which has already been scanned by the at least one energy beam.

Here, the amount of energy introduced can be increased, for example, by increasing the intensity and/or the power of at least one energy beam and/or by increasing the density of scanning vectors, in particular scanning lines, along which at least one energy beam is moved over the material layer and/or by reducing the displacement speed of at least one energy beam. Analogously, the amount of energy introduced can be reduced by reducing the intensity and/or the power of at least one energy beam and/or by reducing the density of scanning vectors, in particular scanning lines, along which at least one energy beam is moved over the material layer and/or by increasing the displacement speed of at least one energy beam.

By way of example, the power of the at least one energy beam can be modulated along a scanning vector and/or from scanning vector to scanning vector depending on a captured temperature distribution.

In a further embodiment, the additional heating of the respectively provided material layer and/or of an already produced component section and/or of a work platform on which the component is constructed is brought about in inductive fashion by means of at least one induction coil. Here, an induction coil should be understood to mean any apparatus that can cause inductive heating. For instance, an individual induction loop should also be understood to mean an induction coil.

The procedure according to the invention was found to be very particularly suitable for the case where the additional heating is implemented inductively. In this case, eddy currents are generated for heating purposes by means of one or more induction coils, in particular in an already produced component section situated under the layer and/or in a work platform situated under a material layer provided. For material layers provided in powder form, heating is generally implemented indirectly by way of solid bodies situated therebelow, which have been heated by induction, since eddy currents, as a rule, are induced to a negligibly small extent in the powder particles as a result of the small size of the particles. However, an inhomogeneous distribution of the eddy currents will set in, in particular, in a component section with an arbitrary geometry, which in turn leads to inhomogeneous heating of the component section and hence also of a material layer situated thereon. In this context, reference is made to the advantageous heating of component edges as an example. When performing the method according to the invention, the inhomogeneities in the temperature distribution are compensated in a particularly simple and, at the same time, particularly efficient fashion by way of controlling the at least one energy beam.

Naturally, any other type of additional heating can be implemented alternatively or additionally within the scope of the procedure according to the invention, with reference being made, purely by way of example, to ohmic heating, heating by means of IR beams and heating by means of electron beams.

The additional heating of an already produced component section and/or of a work platform on which the component is constructed and/or of the respectively provided material layer, as occurs within the scope of the method according to the invention, can furthermore be implemented at the same time as the process of scanning over the material layer with the at least one energy beam and/or can occur therebefore and/or thereafter.

Furthermore, for each of the material layers required for the production of a component with the desired geometry, or else for only some of the material layers, there can be additional heating, therebefore and/or thereafter and/or simultaneously therewith, for the scanning procedure.

In an apparatus of the type set forth at the outset, the present object is achieved by virtue of the apparatus furthermore comprising—capturing means which are embodied to use measurement technology to capture the temperature distribution on the surface of the work platform and/or on a component section already produced above the work platform and/or on a material layer provided on the work platform or on an already produced component section, —control means which are embodied and configured to vary the amount of energy introduced during a scanning procedure by at least one energy beam, provided by the energy beam device, depending on a temperature distribution captured by the capturing means, in particular to vary said amount of energy introduced in such a way that an inhomogeneity in the temperature distribution is compensated or reduced.

In particular, the capturing means may comprise at least one thermographic camera or may be provided by the latter. As an alternative or in addition thereto, the heating means may comprise at least one induction coil or may be formed by the latter.

Further, the control means of the apparatus according to the invention are advantageously embodied and configured to carry out the method according to the invention described above.

The control means can be formed by a computer or comprise the latter. In particular, they are connected, firstly, to the energy beam device and, secondly, to the capturing means for capturing the temperature distribution using measurement technology such that the measurement result in respect of the temperature of a material layer provided can be transferred thereto and, where applicable, can be evaluated, and at least one energy beam, more particularly at least one laser beam, provided by the energy beam device is then controlled on the basis of the result. So that the measurement result in respect of the temperature distribution can be evaluated, the control means are advantageously embodied as control and evaluation means, or else evaluation means are provided and connected to the control means.

Further subject matter of the invention relates to a component, in particular for a turbomachine, which was produced when carrying out the method according to the invention.

### BRIEF DESCRIPTION OF THE DRAWINGS

Further features and advantages of the present invention will become evident from the following description of exemplary embodiments of the apparatus according to the invention and of the method according to the invention, with reference being made to the drawing. In the drawing:

FIG. 1 shows a purely schematic perspective view of an apparatus for the additive production of a component according to an embodiment of the present invention;

FIG. 2 shows a purely schematic sectional illustration of the apparatus of FIG. 1;

FIG. 3 shows a graph where the temperature curve is plotted along a specified line through a thermal image of the surface of an already produced component section, which was captured by means of the thermographic camera of the apparatus of FIG. 1; and

FIG. 4 shows a graph where a curve of the laser power, which compensates the temperature curve from FIG. 3, is plotted in comparison with the constant laser power as per the prior art.

### DETAILED DESCRIPTION OF INVENTION

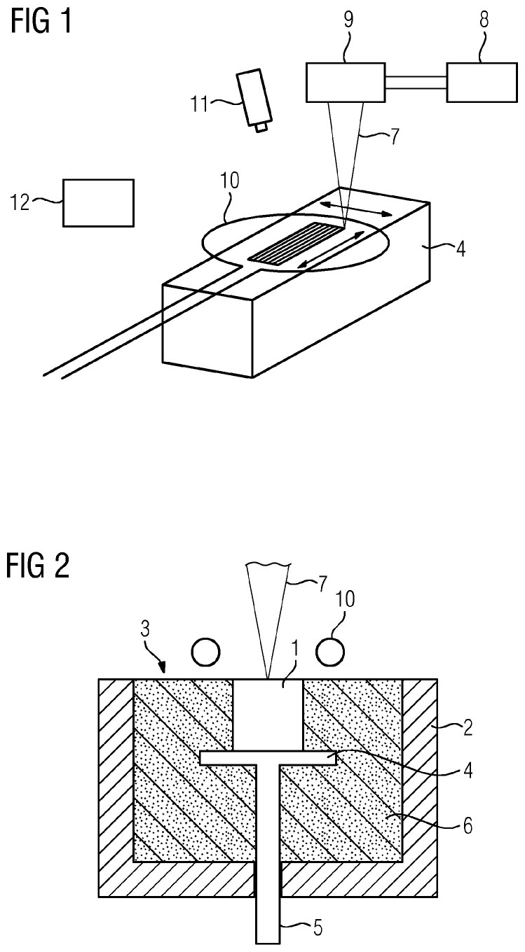

FIGS. 1 and 2 show purely schematic and greatly simplified illustrations of an exemplary embodiment of an apparatus according to the invention for the additive production of a component, an already produced component section 1 of which being evident in the figures. FIG. 1 shows a perspective view and FIG. 2 shows a sectional view. It should be noted that some components of the apparatus are not illustrated in both figures; however, they can be gathered from the respective other figure.

As is sufficiently well known from the prior art, the apparatus comprises a work space 3 defined by a cylinder 2, a work platform 4 being disposed in vertically displaceable fashion in said work space above a stamp 5. Cylinder 2, work space 3 and stamp 5 are only illustrated in FIG. 2.

Furthermore, the apparatus comprises means for providing a multiplicity of powder layers lying on top of one another, said means, as is likewise already known from the prior art, comprising a powder reservoir, which is not illustrated in the figures but disposed directly next to the cylinder 2, and a doctor blade, which is likewise not identifiable. It is evident from FIG. 2 that the cylinder 2 is filled with powder 6. For the purposes of providing a powder layer above the work platform 4 or—from the second powder layer onward—above an already additively produced component section 1 situated thereon, powder 6 is conveyed from the powder reservoir by the doctor blade into the work space 3 and spread out smoothly there, each of which is sufficiently well known.

In order to obtain a component, each of the powder layers provided above one another is selectively fused by means of a laser beam 7 in accordance with a specified component geometry. The laser beam 7 is provided by a laser beam device 8, only illustrated in FIG. 1, of the apparatus and said laser beam is displaced over the powder layer in accordance with the specified geometry by means of a scanning device 9.

Moreover, the apparatus comprises means for inductively heating the work platform 4 or a component section 1 already constructed thereon, said means being provided by an induction coil 10 in the present case. With the aid of the coil 10, eddy currents are induced in the work platform 4 and/or in a component section 1 already produced thereon during operation and said work platform and/or component section is inductively heated during a production procedure. In particular, the formation of hot cracks is avoided or reduced by the additional inductive heating and it is also possible to process materials that can only be welded poorly. A nickel base substance is used in the illustrated exemplary embodiment.

Furthermore, capturing means are provided, which are embodied to use measurement technology to capture the temperature distribution on the surface of the work platform 4 or on a component section 1 already constructed thereover or on the surface of a provided powder layer. In the illustrated exemplary embodiment, the capturing means are provided by a thermal imaging camera 11, only identifiable in FIG. 1, of the apparatus, which “views” in the direction of the work platform 4 or a component section 1 already constructed thereon from above (cf. FIG. 1).

A further constituent part of the apparatus described here is a central control device 12, which is connected to the stamp 5, the means for providing powder layers, the laser beam device 8, the scanning device 9, the coil 10 and the thermal imaging camera 11 or a further control device, not identifiable in the figures, respectively assigned to these.

The method according to the invention for the additive manufacture of components can be carried out using the apparatus from FIGS. 1 and 2.

Here, the temperature distribution on the surface on which the respective powder layer is provided is captured using measurement technology, for each provided powder layer in the present case. In the exemplary embodiment described here, the capture of the temperature distribution using measurement technology is implemented in each case prior to the provision of the layer by virtue of a thermal image of the respective provision surface being recorded using the thermal imaging camera 11. Here, the capture and/or the temporal evaluation of a captured thermal image is advantageously implemented in temporal proximity to the subsequent scanning procedure with the at least one energy beam, more particularly the at least one laser beam. Alternatively, it is also possible for the thermal imaging camera to record continuously and for the thermal images of suitable times to be used in this case.

A block-by-block procedure is possible, in which a temperature distribution is captured per section, as is a completely (quasi) continuous recording, in which an adaptation is undertaken with each recorded thermal image of the camera for the purposes of regulating the power, for example.

In the process, the thermal imaging camera 11 records an image of the thermal radiation emitted by the respective surface in the infrared wavelength range, in a manner known per se. The surface temperature images obtained are available in the form of temperature values for each camera pixel and can be used for further processing. By way of example, the temperatures can be presented in the form of false color or grayscale images for the purposes of presenting these to the user.

The provision surface is the surface of the side of the work platform 4 pointing upward in the figures for the first, lowermost layer and the surface of the side of the respectively already constructed component section 1 pointing upward in FIG. 4 for all further layers.

The thermal image recorded for each layer in advance is evaluated in each case, wherein, specifically, the temperature gradient is ascertained along specified lines which correspond to subsequent scanning lines of the laser beam 7, along which the laser beam 7 is displaced over the respective layer in order to selectively fuse the latter. In the illustrated exemplary embodiment, the laser beam 7 is displaced over the layers in the x- and y-direction, which is indicated in FIG. 1 by two double-headed arrows that are oriented orthogonally to one another.

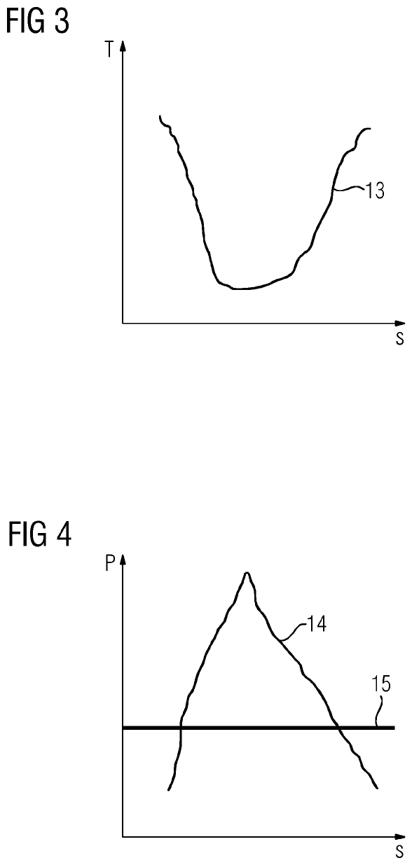

FIG. 3 shows, in exemplary fashion, the ascertained temperature curve 13 along a specified line (here in the x-direction) through a thermal image captured for a component section 1. The y-axis is denoted by “T” for temperature and the x-axis is denoted by “s” for the path length along the component. It is evident that there is a significant inhomogeneity in the temperature distribution along the considered line. Specifically, the edge region has a significantly higher temperature than the center, as can be traced back to preferential heating of component edges within the scope of inductive heating.

According to the invention, the amount of energy introduced by the laser beam 7 during the subsequent scanning procedure is then varied during the displacement along the scanning lines depending on the ascertained temperature gradient, to be precise in such a way that the existing inhomogeneity is reduced or compensated. In the illustrated exemplary embodiment, this is realized by adapting the power of the laser beam 7 during the displacement along the respective scanning line. An exemplary curve of the laser power 14, which compensates the temperature curve 13 illustrated in FIG. 3, can be gathered from FIG. 4. In this graph, the y-axis is denoted by “P” for the laser power and the x-axis is once again denoted by “s” for the path length along the component. By comparing FIGS. 3 and 4, it is evident that the laser power is increased where there is a comparatively lower temperature according to the captured temperature distribution and the laser power has been respectively reduced where there is a comparatively higher temperature according to the captured temperature distribution. The case of constant laser power 15 according to the prior art is likewise illustrated in FIG. 4.

It should be noted that all evaluation and control steps of the described exemplary embodiment are carried out by means of the central control device 12, which is embodied and configured accordingly for the purposes of carrying this out. In the illustrated exemplary embodiment, the control device 12 comprises, inter alia, a computer to this end.

As a result of the procedure according to the invention, a particularly homogeneous energy introduction and consequently a significant improvement in quality are obtained. The process stability is increased and the demands on the concept of additional heating can be reduced. A further significant advantage consists of faster heating times being able to be achieved, and consequently reduction in the build time and in costs.

Even though the invention was illustrated more closely and described in detail by the exemplary embodiment, the invention is not restricted by the disclosed examples and other variations can be derived therefrom by a person skilled in the art without departing from the scope of protection of the invention.

By way of example, the displacement speed of the laser beam 7 can also be adapted as an alternative or in addition to the laser power for the purposes of compensating the inhomogeneous temperature distribution. It is also possible to change the density of the scanning lines. An additional or alternative adaptation of further laser parameters is likewise conceivable so long as this allows a compensation of an existing inhomogeneity on account of the additional inductive heating. Naturally, it is also possible for heating to be performed in any other way as an alternative or in addition to the inductive heating, for example ohmic heating or heating by means of IR beams.

### LIST OF REFERENCE SIGNS

1 Component section
2 Cylinder
3 Work space
4 Work platform
5 Stamp
6 Powder
7 Laser beam
8 Laser beam device
9 Scanning device
10 Coil
11 Thermal imaging camera
12 Central control device

1.-13. (canceled)

14. A method for the additive production of a component, comprising:
successively providing a plurality of layers, more particularly a plurality of layers of a powdery material;
scanning each material layer by at least one energy beam, more particularly at least one laser beam, according to a specified component geometry; and
additional heating of an already produced component section, and/or of the respectively provided material layer, and/or of a work platform on which the component is constructed;
wherein, for at least one material layer, in particular for each material layer, the temperature distribution on the surface on which the material layer is provided is captured using measurement technology, in particular prior to the provision of the layer, and/or the temperature distribution on the surface of the provided layer is captured using measurement technology;
wherein, within the scope of the procedure of scanning over the material layer, varying the amount of energy introduced by the at least one energy beam depending on the captured temperature distribution on the surface on which the layer is provided and/or depending on the captured temperature distribution on the surface of the layer, in particular varied in such a way that an inhomogeneity of the temperature distribution is reduced or compensated;
wherein the temperature distribution on the surface on which the material layer is provided is captured using measurement technology by virtue of a thermal image of this surface being recorded by means of a thermographic camera, and/or the temperature distribution on the surface of the material layer is captured using measurement technology by virtue of a thermal image of the surface of the material layer being recorded by means of a thermographic camera;
wherein at least one captured thermal image is evaluated, and the amount of energy introduced by the at least one energy beam is varied depending on the result of the evaluation; and
wherein at least one temperature gradient is calculated on the basis of the thermal image and the amount of energy introduced by the at least one energy beam is varied during the scanning procedure depending on the calculated temperature gradient.

15. The method as claimed in claim 14,
wherein for the first and lowermost material layer, the temperature distribution on the surface of a work platform on which the first layer is provided is captured using measurement technology, in particular prior to the provision of the first layer, and,
wherein, within the scope of the procedure of scanning over the first layer, the amount of energy introduced by the at least one energy beam is varied depending on the captured temperature distribution on the surface of the work platform.

16. The method as claimed in claim 14,
wherein the amount of energy introduced by the at least one energy beam during the scanning procedure is varied by virtue of the intensity and/or the power and/or the pulse duration and/or the beam or focal diameter and/or the displacement speed of the at least one energy beam and/or the density of scanning vectors, more particularly scanning lines, along which the at least one energy beam is moved over the material layer, being varied during the scanning procedure.

17. The method as claimed in claim 14,
wherein the variation during the scanning procedure is such that the amount of energy introduced by the at least one energy beam is increased where there is a comparatively lower temperature according to the captured temperature distribution, and/or the amount of energy introduced by the at least one energy beam is reduced where there is a comparatively higher temperature according to the captured temperature distribution.

18. The method as claimed in claim 14,
wherein the temperature distribution is captured at least over that region of the surface over which the region of the material layer to be scanned extends.

19. The method as claimed in claim 14,
wherein the additional heating of the respectively provided material layer and/or of an already produced component section and/or of a work platform on which the component is constructed is brought about in inductive fashion by means of at least one induction coil.

20. A component, in particular for a turbomachine, produced according to the method as claimed in claim 14.

21. An apparatus for the additive production of a component, the apparatus comprising:
a work region, defined above a work platform,
means for providing material layers, preferably powdery material layers, above one another in the work region,
an energy beam device, more particularly a laser beam device, which is embodied and configured to emit at least one energy beam, more particularly at least one laser beam, and scan over material layers provided in the work region with the at least one energy beam, more particularly the at least one laser beam, according to a specified component geometry,
means for heating, more particularly inductively heating, a material layer provided in the work region and/or an already produced component section and/or the work platform,
capturing means which are embodied to use measurement technology to capture the temperature distribution on the surface of the work platform and/or on a component section already produced above the work platform and/or on a material layer provided on the work platform or on an already produced component section,
control means which are embodied and configured to vary the amount of energy introduced during a scanning procedure by at least one energy beam, provided by the energy beam device, depending on a temperature distribution captured by the capturing means, in particular to vary said amount of energy introduced in such a way that an inhomogeneity in the temperature distribution is compensated or reduced.

22. The apparatus as claimed in claim 21,
wherein the capturing means comprise at least one thermographic camera or are provided by the latter and/or the heating means comprise at least one induction coil or are provided by the latter.

23. An apparatus, for the additive production of a component, the apparatus comprising:
a control means embodied and configured to carry out the method as claimed in claim 14.
